(19) United States
(12) Patent Application Publication
(10) Pub. No.: US 2001/0013895 A1
(43) Pub. Date: Aug. 16, 2001

(54) Arbitrarily focused image synthesizing apparatus and multi-image simultaneous capturing camera for use therein

(75) Inventors: Kiyoharu Aizawa, Tokyo (JP); Akira Kubota, Tokyo (JP); Yasunori Tsubaki, Tokyo (JP); Conny Gunadi, Tokyo (JP)

Correspondence Address: OLIFF & BERRIDGE, PLC, 277 S. WASHINGTON STREET, SUITE 500, ALEXANDRIA, VA, 22314, US

(73) Assignee: KIYOHARU AIZAWA

(21) Appl. No.: 09/774,646

(22) Filed: Feb. 1, 2001

Related U.S. Application Data
(60) Provisional application No. 60/211,087, filed on Jun. 13, 2000.

(30) Foreign Application Priority Data
Feb. 4, 2000 (JP) 2000-028436

(51) Int. Cl. H04N 5/232

(52) U.S. Cl. 348/222; 348/345; 348/239

(57) ABSTRACT

The object of this invention is to provide an apparatus for reconstructing, from a plurality of images that are focused differently, an arbitrarily focused image that is an image wherein the degree of blur at any depth is suppressed or intensified. A first filter for converting a first image that is in focus in a first portion based on a first blur parameter input from the outside, a second filter for converting a second image that is in focus in a second portion based on a second blur parameter input from the outside, a synthesizer for synthesizing the output of the first filter and the output of the second filter and generating an arbitrarily focused image, and a brightness compensator for performing brightness correction in image block units so that the brightness of the first image and of the second image become about the same, and supplying the images after brightness correction to the first filter and the second filter, are provided.

This non-provisional patent application claims priority from Japanese Patent Application No.2000-28436, filed Feb. 4, 2000 and U.S. Provisional Application No. 60/211,087, filed Jun. 13, 2000.

### BACKGROUND OF THE INVENTION

1. Field of the Invention

This invention relates to an arbitrarily focused image synthesizing apparatus, and to a plural image simultaneous capturing camera for use therein, for reconstructing arbitrarily focused images, from a plurality of images, wherein the degree of blur at each depth is arbitrarily suppressed or intensified.

2. Description of the Related Art

One conventional example of an image processing method for generating a desired image or images from a plurality of images is an image processing method based on region segmentation. With this conventional image processing method, a plurality of differently focused images are prepared, for example, regions in each of those images which are in focus are respectively determined, the plurality of images is subjected to region segmentation based on the results of that determinations a series of processes are performed on those regions to impart prescribed visual effects, and the desired image or images are generated. When so doing, in cases where the series of processes noted above is performed automatically without human intervention, use is generally made of an image processing program, wherein are written procedures for sequentially performing the region determination, region segmentation, and visual effect processing noted above.

In order to generate a desired image or images from a plurality of images, it is first necessary to obtain a plurality of images for the same subject. In order to obtain a plurality of images captured with a conventional camera using different focusing for the same scene, it is necessary to perform a plurality of captures while varying the focus.

More specifically, in a case where n types of image are to be captured with different focus using a conventional camera apparatus, a zoom lens is controlled either manually or by a lens controlling servo device deployed on the outside of the camera, a first image is captured after controlling the focus of the zoom lens so as to focus at a first depth, and then a second image is captured after controlling the focus of the zoom lens so as to focus at a second depth. Thus the n'th image is captured after controlling the focus of the zoom lens 53 so as to focus at an n'th depth in like manner as above. Thus, when it is desired to capture an image focused for n types of depth, the focusing and capturing must be done n times.

With the conventional image processing method described above, a determination condition called “region that is in focus” is employed. Therefore, in cases where regions exist in the scene being photographed having uniform brightness values or depth variation, it is not possible to adequately obtain determination precision in making region determinations for those regions. For that reason, the range wherein the conventional image processing method described above can be applied is limited by the sharpening of the image by integrating the regions that are in focus, etc. In addition, it is extremely difficult therewith to make extensions to more sophisticated image processing such as arbitrarily adjusting the focus blur region by region, or imparting simulated parallax to produce three-dimensional images. Nor is it possible with conventional image processing methods to obtain arbitrarily focused images that are images wherein the degree of depth blur is arbitrarily suppressed or intensified.

### SUMMARY OF THE INVENTION

An object of the present invention, which was devised for the purpose of resolving such problems, is to provide an arbitrarily focused image synthesizing apparatus for reconstructing an arbitrarily focused image, from a plurality of differently focused images, that is an image wherein the degree of blur at each depth is arbitrarily suppressed or intensified.

Another object of the present invention is to provide a plural image simultaneous capturing camera that is capable of simultaneously capturing a plurality of differently focused images.

An arbitrarily focused image synthesizing apparatus of the present invention comprises: a first filter for converting a first image that is in focus in a first portion based on a given first blur parameter; a second filter for converting a second image that is in focus in a second portion based on a given second blur parameter; and a synthesizer for synthesizing output of said first filter and output of said second filter and generating an arbitrarily focused image.

An arbitrarily focused image synthesizing apparatus of the present invention comprises: a first filter for converting a first image that is in focus in a first portion based on a first blur parameter input from the outside; a second filter for converting a second image that is in focus in a second portion based on a second blur parameter input from the outside; a synthesizer for synthesizing the output of the first filter and the output of the second filter and generating an arbitrarily focused image; and a brightness compensator for performing brightness correction in image block units so that the brightness of the first image and of the second image become about the same, and supplying the images after brightness correction to the first filter and the second filter.

An arbitrarily focused image synthesizing apparatus of the present invention comprises: a first filter for converting a first image that is in focus in a first portion based on a first blur parameter input from the outside; a second filter for converting a second image that is in focus in a second portion based on a second blur parameter input from the outside; a synthesizer for synthesizing the output of the first filter and the output of the second filter and generating an arbitrarily focused image; and a positioning unit that positions the first image and the second image, based on a brightness distribution obtained by projecting image data in the horizontal and vertical directions, and supplying positioned images to the first filter and the second filter.

An arbitrarily focused image synthesizing apparatus of the present invention comprises: a first filter for converting a first image that is in focus in a first portion based on a first blur parameter input from the outside; a second filter for converting a second image that is in focus in a second portion based on a second blur parameter input from the outside; a special effects filter for performing prescribed processing on the output of the second filter; and a synthesizer for synthesizing the output of the first filter and the output of the special effects filter and generating an arbitrarily focused image.

A rectangular coordinate to polar coordinate converter for converting coordinates of respective image data from rectangular coordinates to polar coordinates, and a polar coordinate to rectangular coordinate converter for restoring coordinates of image data from polar coordinates back to rectangular coordinates are preferably provided on the input side and output side of the special effects filter.

An arbitrarily focused image synthesizing apparatus of the present invention comprises: a determinator for arranging, in focal point order, first to Nth images wherein first to Nth portions, respectively, are in focus based on first to Nth blur-parameters input from the outside, and determining whether or not one portion in an i'th image that is one of those images is in focus in a plurality of images in front and back thereof taking that i'th image as the center; a comparator for comparing determination patterns of the determinator to determine which images that portion is in focus in; and a synthesizer for synthesizing the first to Nth images according to the comparison results from the comparator and generating a completely focused image.

Preferably, the determinator should comprise a Gaussian filter for subjecting the i'th image to filter processing while varying the parameters, a differential processor for finding differential values of the plurality of images in front and back with the output of the Gaussian filter, and an estimator for estimating the parameters by finding value or values at which the differential values become extremely small.

A plural image simultaneous capturing camera relating to the present invention comprises: a camera element; a processor for receiving signals from the camera element and converting them to image data; a display unit for displaying image data processed by the processor; a focal point designator for designating a plurality of subjects inside an image and requesting a plurality of images having respectively differing focal points; a focal point adjustment mechanism for setting focal point positions by the designation of the focal point designator; and a memory for storing image data; wherein the processor respectively and in order focuses the plurality of subjects designated, respectively captures those subjects, and respectively stores the plural image data obtained in the memory.

Preferably, a plurality of images having different focal points should be captured with one shutter operation.

Preferably, an arbitrarily focused image synthesizing apparatus should be comprised which comprises: a first filter for converting a first image that is in focus in a first portion based on a first blur parameter input from the outside; a second filter for converting a second image that is in focus in a second portion based on a second blur parameter input from the outside; a synthesizer for synthesizing the output of the first filter and the output of the second filter and generating an arbitrarily focused image; and a brightness compensator for performing brightness correction in image block units so that the brightness of the first image and of the second image become about the same, and supplying the images after brightness correction to the first filter and the second filter.

Preferably, an arbitrarily focused image synthesizing apparatus should be comprised which comprises: a first filter for converting a first image that is in focus in a first portion based an a first blur parameter input from the outside; a second filter for converting a second image that is in focus in a second portion based on a second blur parameter input from the outside; a synthesizer for synthesizing the output of the first filter and the output of the second filter and generating an arbitrarily focused image; and a positioning unit that positions the first image and the second image, based on a brightness distribution obtained by projecting image data in the horizontal and vertical directions, and supplying positioned images to the first filter and the second filter.

Preferably, an arbitrarily focused image synthesizing apparatus should be comprised which comprises: a first filter for converting a first image that is in focus in a first portion based on a first blur parameter input from the outside; a second filter for converting a second image that is in focus in a second portion based on a second blur parameter input from the outside; a special effects filter for performing prescribed processing on the output of the second filter; and a synthesizer for synthesizing the output of the first filter and the output of the special effects filter and generating an arbitrarily focused image.

A rectangular coordinate to polar coordinate converter for converting coordinates of respective image data from rectangular coordinates to polar coordinates, and a polar coordinate to rectangular coordinate converter for restoring coordinates of image data from polar coordinates back to rectangular coordinates are preferably provided on the input side and output side of the special effects filter.

A recording medium relating to the present invention is a medium whereon is recorded a program for causing a computer to function as one of either the arbitrarily focused image synthesizing apparatuses or the plural image simultaneous capturing cameras described in the foregoing.

Such medium may be a floppy disk, hard disk, magnetic tape, optical magnetic disk, CD-ROM, DVD, ROM cartridge, RAM memory cartridge backed up by a battery pack, flush memory cartridge, or non-volatile MM cartridge, etc.

Such medium may also be a communication medium such as a land-wire communication medium such as a telephone line, or a wireless communication medium such as a microwave line. Communication medium as used here is also inclusive of the internet.

By medium is meant anything whereby information (primarily meaning digital data and programs) is recorded by some physical means or other, and which is capable of causing a computer or dedicated processor or the like to function as a processing device. In other words, such may be anything wherewith a program is downloaded by some means or other to a computer and that computer is caused to perform prescribed functions.

### BRIEF DESCRIPTION OF THE DRAWINGS

FIG. 1 is a simplified block diagram of an apparatus for reconstructing completely focused images and/or arbitrarily focused images, relating to Embodiment 1 of the present invention;

FIG. 2 is a model for the reconstruction of an arbitrarily focused image f, relating to Embodiment 1 of the present invention;

FIG. 3 plots frequency characteristics for reconstruction filters Ka and Kb relating to Embodiment 1 of the present invention;

FIG. 4 is a diagram for describing brightness correction in block units relating to Embodiment 2 of the present invention;

FIG. 5 provides an explanatory diagram and flow chart for procedures for positioning between a plurality of focused images by a hierarchical matching method relating to Embodiment 3 of the present invention;

FIG. 6 is a block diagram of an apparatus for positioning between a plurality of focused images by a brightness projection method relating to Embodiment 4 of the present invention;

FIG. 7 is an explanation of positioning between a plurality of focused images by the brightness projection method relating to Embodiment 4 of the present invention;

FIG. 8 is a set of simplified block diagrams of apparatuses for reconstructing completely focused images and/or arbitrarily focused images that comprise a filter for special effects, relating to Embodiment 5 of the present invention;

FIG. 9 is a simplified block diagram of a digital camera relating to Embodiment 6 of the present invention;

FIG. 10 is a diagram for describing the operations of the digital camera relating to Embodiment 6 of the present invention;

FIG. 11 is an operational flow chart for the digital camera relating to Embodiment 6 of the present invention;

FIG. 12 is a set of explanatory diagrams for a method of generating a completely focused image based on a plurality of images, relating to Embodiment 7 of the present invention; and

FIG. 13 is an explanatory diagram for blur amount estimation relating to Embodiment 8 of the present invention.

### DESCRIPTION OF THE PREFERRED EMBODIMENTS

Embodiment 1.

In an embodiment of the present invention, an apparatus and method are described for reconstructing, from a plurality of images, a completely focused image wherein both near scenic content and far scenic content are completely focused, and/or an arbitrarily focused image that is an image wherein the degree of blur at each depth is arbitrarily suppressed or intensified.

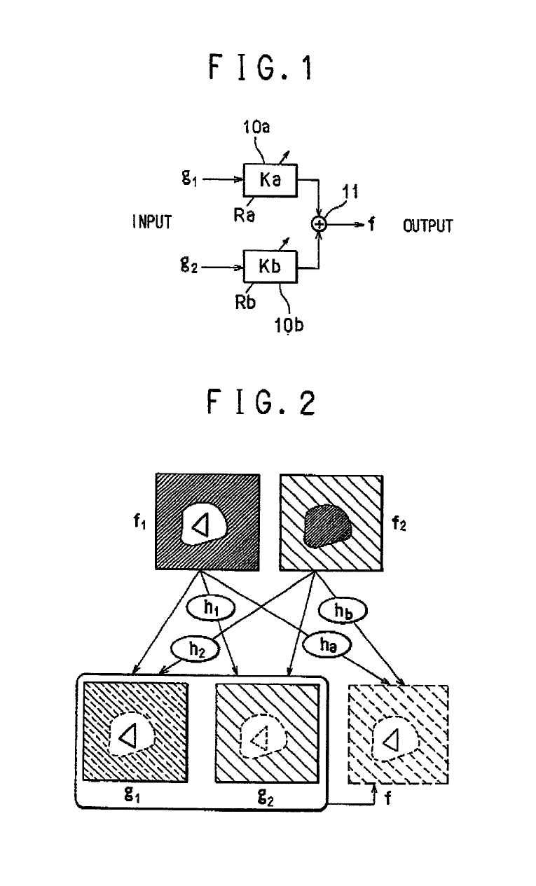

A simple description is given now of a method for reconstructing a desired arbitrarily focused image f from a near content in-focus image g1 and a far content in-focus image g2. FIG. 1 is a simplified block diagram of an apparatus relating to an embodiment of the present invention. This apparatus is capable of reconstructing both a completely focused image and an arbitrarily focused image from the near content image g1 and the far content image g2. A filter 10a subjects the near content image g1 to prescribed processing, and a filter 10b subjects the far content image g2 to prescribed processing. The details of these filters are described subsequently. A synthesizer 11 synthesizes the output of the filter 10a and the output of the filter 10b and outputs a reconstructed image f. The filters 10a and 10b receive parameters Ra and Rb, respectively, from the outside. These parameters Ra and Rb, respectively, are near content and far content blur radiuses for the desired image. When Ra=Rb=0, the reconstructed image f will be a completely focused image. By adjusting the parameters Ra and Rb, an arbitrarily focused image can be reconstructed.

When a completely focused image is to be generated, for example, both the first filter for near scenic content and the second filter for far scenic content have high-pass characteristics. A completely focused image can be obtained by extracting high-band components from a first image and a second image with good balance by first and second filters and adding these together. An arbitrarily focused image can also be generated by innovatively setting the filter characteristics. Specific filter characteristics are described subsequently.

The apparatus and method of the embodiment of this invention are based on the fact that, in a model for acquiring focused images and arbitrarily focused images, one filter exists for reconstructing one target image. With a conventional recursive restoration method, the direct current components of the target image constitute what in terms of image restoration are called adverse conditions (ill-conditions). In the embodiment of the present invention, reconstruction filter direct current components exist, whereupon all frequency components can be reconstructed.

First, models for acquiring focused images and reconstructing arbitrarily focused images are examined.

In the method for reconstructing arbitrarily focused images, it is assumed that the depth of a subject scene for an acquired image varies in stepwise fashion. Models are now posited for acquiring focused images and reconstructing arbitrarily focused images, for a case wherein the subject scene has two layers of depth for near scenic content and far scenic content, respectively.

<Focused Image Acquisition Model>

A focused image acquisition model is made using image stacking. An image f1 is defined as an image having focused brightness values only in the near content region, such that the brightness value is 0 in all other regions, that is, in the far content region or regions. Conversely, an image f2 is defined as an image having focused brightness values only in the far content region, such that in the near content region the brightness value is 0. The near content in-focus image is represented as g1 and the far content in-focus image as g2. A blur function for the far content region in the image g1 is represented as h2, and a blur function for the near content region in image g2 is represented as h1. A model for acquiring the focused images g1 and g2 is represented as stacking as diagrammed in FIG. 2.

g1=f1+h2*f2

g2=h1*f1+f2 (6)

where * represents a convolution computation.

<Arbitrarily Focused Image Reconstruction Model>

Image stacking is also used, in like manner, for the arbitrarily focused image reconstruction model. The desired arbitrarily focused image is represented by f, and blur is imparted to the near content and far content regions by the blur functions ha and hb, respectively. Accordingly, as diagrammed in Pig. 2, the model for reconstructing the arbitrarily focused image f is represented by the following formula.

f=ha*f1+hb*f2 (7)

The blur functions ha and hb are designated arbitrarily by the user.

The Gaussian function given by the following formula is need for the blur functions.

$${h}_{i} ( x , y ) = \frac{1}{π {R}_{i}^{2}} exp ( - \frac{{x}^{2} + {y}^{2}}{{R}_{i}^{2}} ) \qquad ( 8 )$$

Ri (i=1, 2, a, b) represents the blur radius, corresponding to \sqrt{2} times the standard deviation of the Gaussian function. If Ra=Rb=0, we have ha=hb=δ (delta function), so formula (7) becomes a completely focused image reconstruction model.

A reconstruction method that uses a filter is described

Using a filter, a desired arbitrarily focused image f can be reconstructed from the focused images g1 and g2. It was demonstrated in simulations that this method is faster and higher in precision than the conventional recursive restoration method. This method is now described.

<Reconstruction Filter Derivation>

The reconstruction filter is derived from the model for acquiring g1 and g2 in formula (7) and the model for reconstructing f in formula (7).

To begin with, each model is converted to a frequency domain. A model for acquiring G1 and G2 can be represented by (a) matrix(es), as in the following formula.

G=HF (17)

where each matrix is given by

$$G = ( \begin{matrix}{G}_{1} \\ {G}_{2}\end{matrix} ) , H = ( \begin{matrix}1 & {H}_{2} \\ {H}_{1} & 1\end{matrix} ) , F = ( \begin{matrix}{F}_{1} \\ {F}_{2}\end{matrix} )$$

The model for reconstructing F is then given by the following formula.

F=HaF1+HbF2 (18)

Next, F is derived from formula (17) and formula (18). Cases are differentiated according to the value of the matrix formula |H|. Furthermore, |H|=1−H1H2, and, |H| is equal to H in G=HF resulting when both sides of g=h*f (using images f, g, and blur function h) are subjected to Fourier transformation.

(i) Case where |H|≠0

When 1−H1H2≠0, that is, at any frequency other than direct current, the inverse matrix H⁻¹ exists. Accordingly, the matrix F is found as follows.

$$\begin{matrix}F = {H}^{- 1} G \\ = \frac{1}{1 - {H}_{1} {H}_{2}} ( \begin{matrix}{G}_{1} - {H}_{2} {G}_{2} \\ - {H}_{1} {G}_{1} + {G}_{1}\end{matrix} )\end{matrix} \qquad ( 19 )$$

By substituting F in formula (18), he following formula is derived.

$$F = \frac{{H}_{a} - {H}_{b} {H}_{1}}{1 - {H}_{1} {H}_{2}} {G}_{1} + \frac{{H}_{b} - {H}_{a} {H}_{2}}{1 - {H}_{1} {H}_{2}} {G}_{2} \qquad ( 20 )$$

(ii) case where |H|=0

Because at direct current (1−H1H2)=0, the inverse matrix H⁻¹ does not exist. Accordingly, the matrix F cannot be derived. However, in formula (20), the numerators in the coefficients for G1 and G2 are Ha−HbH1=0 and Hb−HaH2=0. That being so, if the limits of these coefficients toward direct current are solved for using the L'Hospital's theorem, the following limits exist.

$$\begin{matrix}{lim}_{ξ , n \to 0} \frac{{H}_{a} - {H}_{b} {H}_{1}}{1 - {H}_{1} {H}_{2}} = \frac{{R}_{1}^{2} + {R}_{b}^{2} - {R}_{a}^{2}}{{R}_{1}^{2} + {R}_{2}^{2}} & ( 21 ) \\ {lim}_{ξ , n \to 0} \frac{{H}_{b} - {H}_{2} {H}_{1}}{1 - {H}_{1} {H}_{2}} = \frac{{R}_{2}^{2} + {R}_{a}^{2} - {R}_{b}^{2}}{{R}_{1}^{2} + {R}_{2}^{2}} & ( 22 )\end{matrix}$$

Therefore, from (i) and (ii), it will be seen that F can be reconstructed, as in formula (25) below, from the filters Ka and Kb represented in formulas (23) and (24) below.

$$\begin{matrix}{K}_{a} ( ξ , η ) = \{ \begin{matrix}\frac{{R}_{1}^{2} + {R}_{b}^{2} - {R}_{a}^{2}}{{R}_{1}^{2} + {R}_{2}^{2}} , & ξ = η = 0 \\ \frac{{H}_{a} - {H}_{b} {H}_{1}}{1 - {H}_{1} {H}_{2}} , & otherwise\end{matrix} & ( 23 ) \\ {K}_{b} ( ξ , η ) = \{ \begin{matrix}\frac{{R}_{2}^{2} + {R}_{a}^{2} - {R}_{b}^{2}}{{R}_{1}^{2} + {R}_{2}^{2}} , & ξ = η = 0 \\ \frac{{H}_{b} - {H}_{a} {H}_{2}}{1 - {H}_{1} {H}_{2}} , & otherwise\end{matrix} & ( 24 ) \\ Fab = KaG1 + KbG2 & ( 25 )\end{matrix}$$

As diagrammed in FIG. 1, after passing the focused images g1 and g2 through the filters Ka and Kb, respectively, the arbitrarily focused image f can be obtained by adding the results. By altering Ra and Rb, the blur for near scenic content and far scenic content, respectively, can be set arbitrarily. In the commonly known recursive restoration method, the direct current component become ill-posed condition, but it is here demonstrated that this can be made a well-posed problem and solved using the filter method. That is, it is demonstrated by this method that a unique f exists and that it can be determined.

<Reconstruction Filter Characteristics>

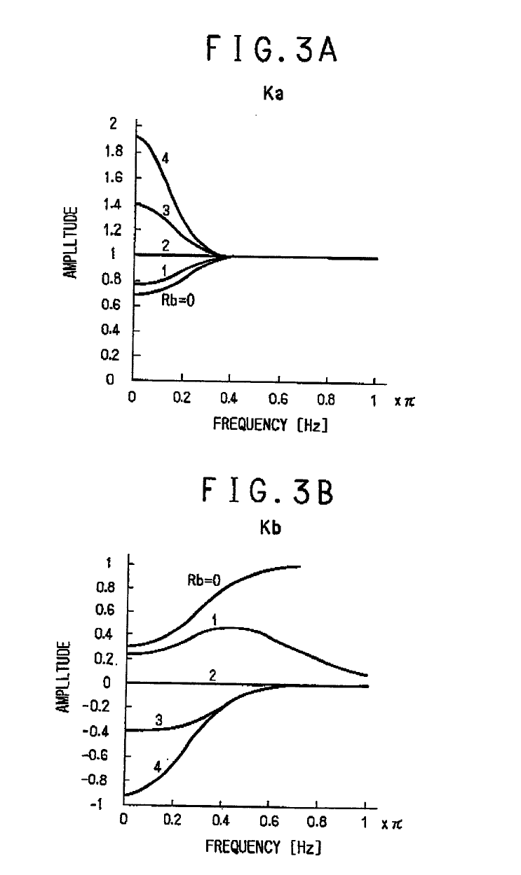

Example frequency characteristics for the reconstruction filters Ka and Kb are plotted in FIG. 3. First, in two images, the blur radius for the near scenic content is set to R1=3 in the image (g2) where the far scenic content is in focus, and the blur radius for the far scenic content is set to R2=2 in the image (g1) where the near scenic content is in focus. Thereupon, the characteristics for the filters Ka and Kb are plotted in FIG. 3 for the case where, for an arbitrarily focused image, Ra is set to Ra=0 and Rb is made to vary from 0 to 4. This connotes processing which greatly varies the degree of blur in the far content region while leaving the near content region in focus.

Because Ra is set to Ra=0, the characteristics are indicated for filters for reconstructing a completely focused image when Rb=0. High-pass filter-like characteristics are indicated for both filters. That is, we see here that the high frequency components of each focused image are integrated and a completely focused image is reconstructed. When Rb=2, Ka exhibits all-band passage characteristics and Kb exhibits all-band blocking characteristics. The reason therefor is that thereupon the arbitrarily focused image f is identical with the focused image g1. When Rb>2, Ka exhibits low-band intensifying characteristics while continuing to pass high-band components. Rb then exhibits characteristics such that the negative portion of the low-band components is intensified while continuing to block the high-band components. We see that by subtracting the intensified low-band components in the focused image or images the blur in the far content region is intensified.

It was learned as a result of simulations that, by using the filter method, as compared to the recursive method, both precision and computation time were improved. With the recursive method, much time is required for the blur function convolution computations in the space region or regions. It is possible, moreover, that there will be larger errors in propagation as the number of blur function convolutions is increased. With this filter method, the desired image can be reconstructed directly with one process by using filters.

Embodiment 2.

In the procedures described in the foregoing for reconstructing and generating an arbitrarily focused image by filter processing two focused images, if there is a difference in the average brightness level between the plurality of images used, there will be cases where it will not be possible to reconstruct a good image. Photographic devices such as digital cameras have a function for automatically adjusting the brightness (AGC), wherefore the brightness of the near content image will not always match the brightness of the far content image. It is therefore preferable that brightness correction be implemented as described below. when reconstructing a desired arbitrarily focused image f from a near content in-focus image g9 and a far content in-focus image g2, parameters A and B that minimize the cost function given below are estimated using the method of least squares. When this is being done, it is desirable that the cost function described below be evaluated between images arranged in a hierarchy, taking the difference in the amount of blur between the two images into consideration. The images in the k'th level of a Gaussian pyramid are here designated g1(k) and g2(k), respectively (subsequently described in detail). The O'th level is made the origin image or images.

$$J = {\sum }_{i , j} {\vert {g}_{1}^{( k )} ( i , j ) - ( {Ag}_{2}^{( k )} ( i , j ) + B ) \vert}^{2}$$

It was demonstrated in simulations that the parameters A and B can be estimated with high precision by this method. In an image generated using the image g2 prior to correction, the brightness values were down over the entire screen, and artifacts were observed with intensified edges in the far content region. In contrast therewith, the image generated using the post-correction image or images could be generated well. In the generation of a arbitrarily focused image to which greater blur is imparted than the blur in the observed image, the low-band components of the filters Ka and Kb used in the generation become large positively and negatively, respectively. For that reason, it may be conjectured that the difference in average brightness values causes such artifacts as these to appear in the generated image. Accordingly, by implementing brightness correction, it is possible to avoid the problem of the appearance of artifacts having intensified edges and lowered brightness in images generated with intensified blur.

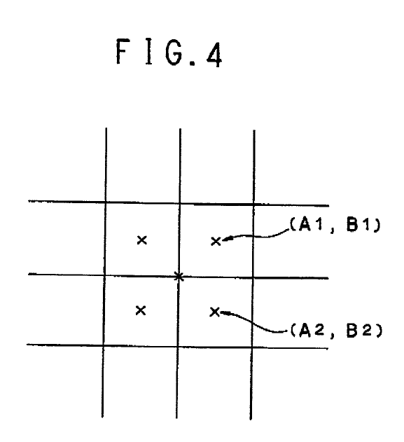

When image capture is done while varying the focal point between the center and edges of the screen, brightness fluctuation develops in the screen. In such cases, it is necessary to divide the screen into blocks and find suitable correction parameters for each block. In such cases, the processing described above will be done block by block. In order to reduce the variation in correction between the blocks, moreover, correction parameters for each block are used for the center pixel in each block, as diagrammed in FIG. 4, while bilinearly interpolated correction parameters are used for the other pixels.

In order to stabilize the precision of correction parameter estimation, moreover, the following formula is sometimes used for an evaluation quantity.

[Σg1(i, j)−A*Σg2(i, j)]²

where (i, j)∈B (finding the summation for elements in block B)

In this case, it could be said that corrections will be made by the ratio (A) of the average brightness values in the block.

When many images are to be synthesized, brightness corrections may be made in block units In the case of synthesizing N images, for example, N capture images are respectively divided into square blocks, as diagrammed in FIG. 4. It is assumed that corrections are made sequentially such that the k+1'th image is matched with the k'th image (where k=1, 2, . . . , N−1). The ratio of the average brightness values between the images for each block is found and made the correction parameter for the center pixel in that block. Correction parameters for pixels other than the center pixel are found by bilinear interpolation. Then the brightness corrections are finally made by multiplying the pixel brightness values by the correction parameters. When the ratio of regions where brightness saturation occurs in a block in one or other of the images rises to a certain value, the correction parameter for the center pixel in that block is interpolated as the average value of those for the surrounding blocks.

Embodiment 3.

In order to employ a plurality of focused images in reconstruction processing, it becomes necessary to implement positioning (registration) between those images. When capturing a plurality of focused images, it is very difficult to obtain images wherewith the capture positions mutually and accurately coincide. Variation in magnification also occurs due to focusing differences. It positioning precision is poor, not only will the reproduced image be blurred, but the precision wherewith the blur parameters necessary to the reconstruction can be estimated will be affected also. This will also lead, as a consequence, to a decline in the precision of the reconstructed image. Positioning (registration) is therefore a necessary preprocess in reconstructing and generating high precision images.

<Positioning Between Multiple Focused Images (Part 1: Hierarchical Matching Method)>

In order to reconstruct the desired arbitrarily focused image f from a near content focused image g1 and a far content focused image g2, it is first necessary to perform positioning (registration) between the focused images. A method is described below for effecting positioning between a plurality of focal point images.

It is first assumed that two images have been obtained, namely an image In that is in focus in the near scenic content and an image if that is in focus in the far scenic content.

With In as the reference, differences in the rotation, resizing, and translation of If (represented, in order, by θ, s, and vector t=(u, v)) are estimated. In this case, for resizing, it is only necessary to consider enlargement due to the focal length relationships involved. In handling this problem with this method, using the hierarchical matching method, rotation and enlargement/reduction parameters are combined and each parameter is sought roughly and precisely. Because the focused regions and unfocused regions are different between In and If, it is very likely that errors will occur if matching is done directly If the hierarchical matching method is employed, matching can be done such that the difference in blur between the two images is reduced by ordering the images in a hierarchy. It is believed that, as a consequence, robust positioning can be performed relative to blur differences.

The process flow in this method is (1) hierarchical ordering of images and (2) estimation of parameters at each level. To begin with, both images are hierarchically ordered, and parameters are found over a wide search range at the uppermost level where the resolution is lowest. Thereafter, matching is performed sequentially, while limiting the search range to the margins of the parameters estimated at the upper levels, and finding the parameters between the original images last of all. The method is now described explicitly, following the process flow.

(1) Hierarchical ordering of Images

The hierarchical ordering of the two images is done by forming a Gaussian pyramid. The Gaussian pyramid is formed as follows. Taking the original image or images as the O'th layer, and the uppermost layer having the lowest resolution as the L'th layer, the focused images in the k'th layer (where k=0, 1, . . . , L) are expressed as In(k) and If(k). Then the images in each level are formed sequentially according to the following formula.

$$\begin{matrix}{I}_{n}^{( k )} = {( [ {I}_{n}^{( k - 1 )} * w ] )}_{↓ 2} , {I}_{n}^{( 0 )} = {I}_{n} & ( 1 ) \\ {I}_{f}^{( k )} = {( [ {I}_{f}^{( k - 1 )} * w ] )}_{↓ 2} , {I}_{f}^{( 0 )} = {I}_{f} & ( 2 ) \\ w = ( \begin{matrix}1 & 5 & 8 & 5 & 1 \\ 5 & 25 & 40 & 25 & 5 \\ 8 & 40 & 64 & 40 & 8 \\ 5 & 25 & 40 & 25 & 5 \\ 1 & 5 & 8 & 5 & 1\end{matrix} ) \frac{1}{400} & ( 3 )\end{matrix}$$

Here, w is obtained by approximating a second degree Gaussian function having a standard deviation of 1. The notation [ ]⇓2 represents down sampling. An image or images at the k'th level is/are obtained by passing an image or images at the k−l'th level through a Gaussian filter and down-sampling. The Gaussian filter acts as a low-pass filter, wherefore the difference in the level of blur between the two images is decreased more at the upper level or levels.

(2) Estimating Parameters in Levels

In this method, parameters are found for minimizing the mean square error (MSE) between the images If(x′, y′) and In(x′, y′) obtained by rotating, resizing, and translating the image If(x, y). If the parameters at the k'th level are made θ(k), s(k), u(k), and v(k), the evaluation function J(k) to be minimized at the k'th level can be represented as follows.

$${J}^{( k )} ( {θ}^{( k )} , {s}^{( k )} , {u}^{( k )} , {v}^{( k )} ) = \frac{1}{{N}_{B}^{( k )}} \cdot {\sum }_{( x , y ) ∈ {B}^{( k )}} {\vert {I}_{n}^{( k )} ( x , y ) - {I}_{f}^{( k )} ( {x}^{′} , {y}^{′} ) \vert}^{2} \qquad ( 4 )$$

Here we have

$$( \begin{matrix}{x}^{′} \\ {y}^{′}\end{matrix} ) = {s}^{( k )} ( \begin{matrix}cos {θ}^{( k )} & - sin {θ}^{( k )} \\ sin {θ}^{( k )} & cos {θ}^{( k )}\end{matrix} ) ( \begin{matrix}x \\ y\end{matrix} ) + ( \begin{matrix}{u}^{( k )} \\ {v}^{( k )}\end{matrix} ) \qquad ( 5 )$$

where B(k) is an overlapping region between In(k) (x, y) and If(k) (x′, y′), and NB(k) is the number of pixels therein.

The search points for the parameters are established by hierarchical level as follows.

(i) Case where k=L

$${θ}^{( L )} = i \cdot {2}^{L} Δθ , ( - {θ}_{max} ≦ {θ}^{( L )} ≦ {θ}_{max} )$$

$${s}^{( L )} = j \cdot {2}^{L} Δ s , ( 1 ≦ {s}^{( L )} ≦ {s}_{max} )$$

$${u}^{( L )} = m \cdot Δ u , ( - {u}_{max} ≦ {u}^{( L )} ≦ {u}_{max} )$$

$${v}^{( L )} = n \cdot Δ v , ( - {v}_{max} ≦ {v}^{( L )} ≦ {v}_{max} )$$

(ii) Case where k<L

$${θ}^{( k )} = {\hat{θ}}^{( k + 1 )} + i \cdot {2}^{k} Δ θ , ( - 2 ≦ i ≦ 2 )$$

$${s}^{( k )} = {\hat{s}}^{( k + 1 )} + j \cdot {2}^{k} Δ s , ( - 2 ≦ j ≦ 2 )$$

$${u}^{( k )} = 2 {\hat{u}}^{( k + 1 )} + m \cdot Δ u , ( - 2 ≦ m ≦ 2 )$$

$${v}^{( k )} = 2 {\hat{v}}^{( k + 1 )} + n \cdot Δ v , ( - 2 ≦ n ≦ 2 )$$

In the formulas above, i, j, m, and n are integers, and Δθ, Δs, Δu, and Δv are search intervals between the original images, that is, estimation precision values for each of the parameters. Hat θ(k+1), hat s(k+1), hat u(k+1), and hat v(k+1) represent parameters estimated at the upper k+1'th level. θmax, smax, umax, and vmax are values which limit the search ranges at the uppermost layer, and are set beforehand. The values of umax and vmax, however, respectively, are made half the size of the sides of the images in the uppermost layer. The search intervals Δu and Δv for the translation parameters at each level are constant because the translation quantity at the k'th level is equivalent to twice that at the k+1'th level.

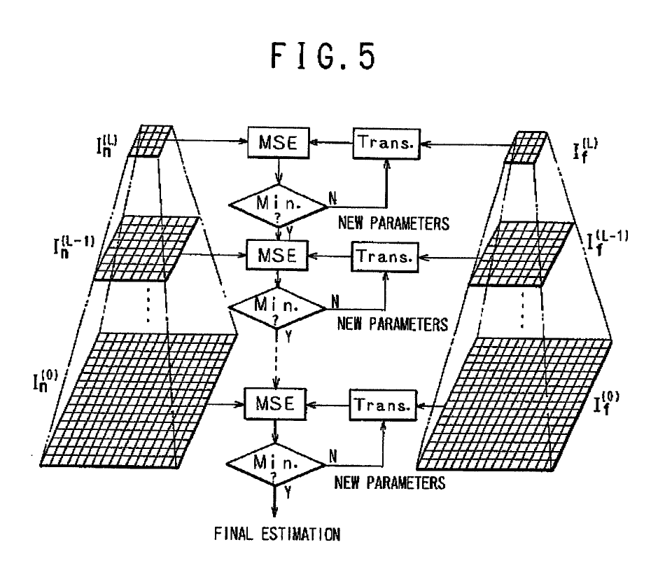

The flow of estimations in this method is diagrammed in FIG. 5. At each level, parameters are sought for minimizing the MSE between the image In(k) (x, y), on the one hand, and the image If(k) (x′, y′) that has been subjected to rotation, resizing, and translation conversions, on the other. At the uppermost level (k=L) where the resolution is the lowest, the parameters are roughly estimated with wide intervals within the search range established beforehand. The search interval there is equivalent to 2_{L} times that at the lowermost level. At levels other than the uppermost level, searches are conducted, sequentially, with the estimation precision doubled while limiting the search range to five points at the margins of the parameters estimated at the upper level or levels. These searches are performed until the lowermost level is reached, whereupon the final parameter estimations are made.

Finally, the region or regions common to the images In (x, y) and If (x′, y′) subjected to the estimated parameters, rotation, resizing, and translation, are extracted and the respective corrected images are obtained. Such correction can be performed also in cases where the subject scene consists of three or more layers by making the nearest content focused image the reference, performing positioning (registration) on the other images, and extracting the common region or regions.

It was demonstrated in simulations that true estimations could made in all cases if the blur radius was small in each resizing. Good results were also obtained in cases where the blur radius was large, with maximum error held down to 2 [pixels]. In no case did an error of 3 [pixels] or more occur.

Embodiment 4.

<Positioning Between Multiple Focused Images (Part 2; Brightness Projection)>

With the hierarchy matching method in Embodiment 3 of the present invention described in the foregoing, while there is no problem in terms of precision, there are nevertheless problems in that processing is both complex and time-consuming. That being so, a brightness projection method is proposed which is simple and permits high speed processing.

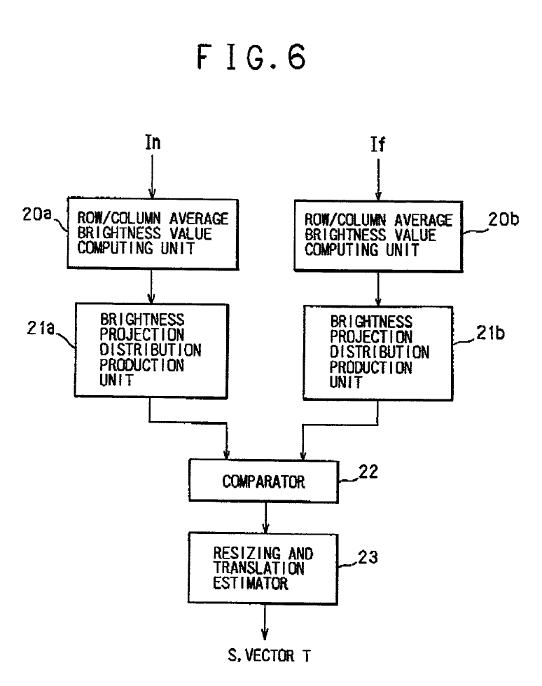

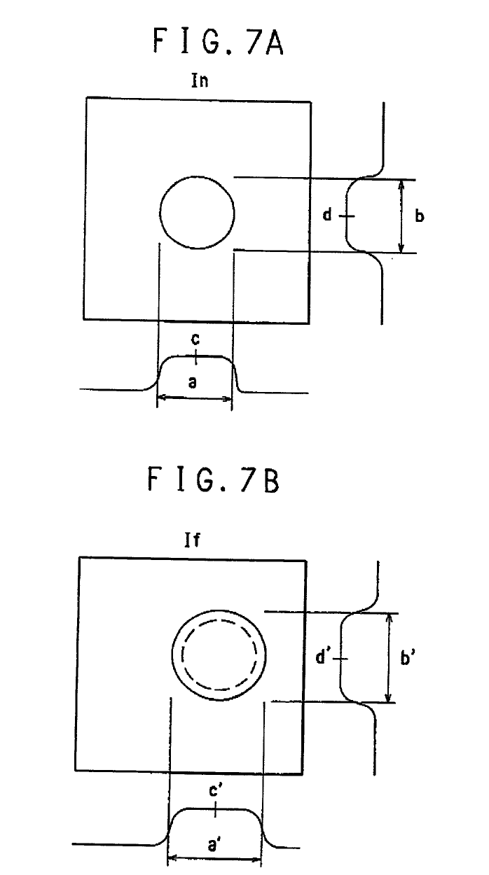

With this method, differences in resizing and translation (s, vector t=(u, v)) of the far content image If can be estimated when the near content image In is made the reference. In FIG. 6 is given a block diagram of a positioning (registration) apparatus for positioning between a plurality of focused images by the brightness projection method. In FIG. 7 are given explanatory diagrams for the operations thereof. Average brightness value computing units 20a and 20b for each row and each column compute average brightness values for each row and each column in the input images In and If, respectively. Brightness projection distribution production units 21a and 21b produce brightness projection distributions for In and If, respectively. The average brightness value distribution for each row is made a vertical distribution and the average brightness value distribution for each row a horizontal distribution. By performing these processes, brightness distributions are obtained for In and If, as diagrammed in FIG. 7(a) and 7(b). The dashed line circle in FIG. 7(b) is a circle of the same size as the circle in FIG. 7(a). Thus each image is represented as a combination of two one-dimensional distributions, namely a horizontal distribution and a vertical distribution. A comparator 22 compares these two distributions, with In as the reference. Based on the results of this comparison, an enlargement and translation estimator 23 estimates the differences in If enlargement and translation (in the order of s, t=(u, v)). When the subject being photographed is a circle shape, for example, in the brightness projection for the near content image In in FIG. 7(a), the center c and diameter a are assumed in the horizontal distribution therefor, and the center d and diameter b are assumed in the vertical distribution therefor. In the brightness projection for the far content image If in FIG. 7(b), the center c′ and diameter a′ are assumed in the horizontal distribution therefor, and the center do and diameter b′ are assumed in the vertical distribution therefor. The enlargement s can be estimated from a′/a and b′/b. The horizontal component U of the translation t can be estimated from c′-c, and the vertical component v thereof from d′-d.

With the brightness projection method, as compared to the hierarchy matching method, the computation volume is significantly less and speed becomes much faster. According to the results of simulations, the processing time was reduced to approximately 1/200. Precision is slightly sacrificed, on the other hand, but, even at that, error was held down to vary only by 1 pixel or so, and the results obtained were good.

Embodiment 5.

The configuration of an apparatus for obtaining completely focused images is diagrammed in FIG. 1. This e configuration is the most basic configuration. By adding filters to this configuration, special effects can be imparted to totally focused images.

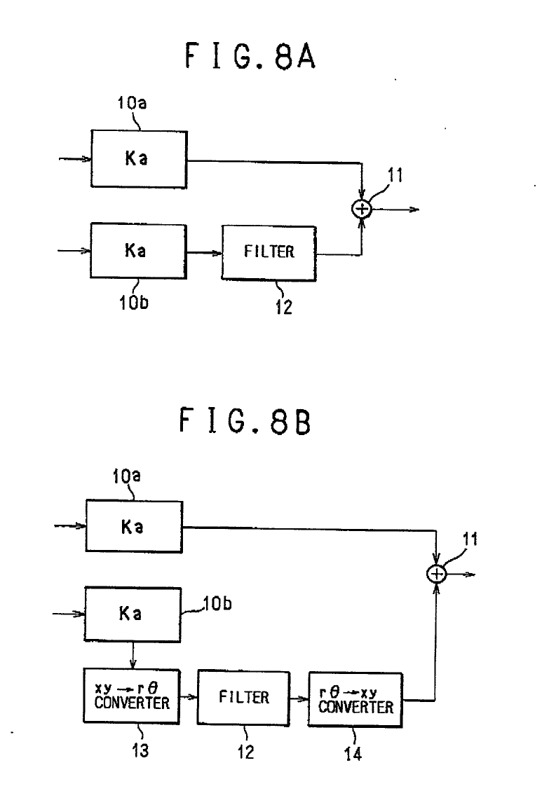

One example thereof is diagrammed in FIG. 8(a). Filters 10a and 10b are filters for focus processing, while a filter 12 is a filter for separate special processing. The filter 12 is deployed on the far content image g2. This filter may be any filter, but, to cite one example, one that adds together pixel data in the lateral (or vertical) direction may be considered. When the data d0, d1, d2, d3, d4, etc. exist in the lateral direction, d2=(d2+d1+d0)/3, d3=(d3+d2+d1)/3, and so forth. Data in the vertical (or lateral) direction is left unaltered. When this filter is used, the far content image g2 is converted to an image that flows in the lateral direction, and that converted image is synthesized with the near content image g1. The synthesized image is an image that might be called “panned.”

It is also permissible to provide a rectangular coordinate to polar coordinate converter 13 and a polar coordinate to rectangular coordinate converter 14 before and after the filter, as diagrammed in FIG. 8(b). Based on this configuration, the far content image g2 is converted to an image that seems to flow out radially, and that is synthesized with the near content image g1. That is, if the origin of the polar coordinates is made to coincide with the center of the near content image, then the synthesized image will be an image having a background that seems to flow, with the near content image (a person, for example) as the center. The filter described above may also be one that performs processing for such non-linear geometric conversions as logarithmic conversion. For example, this filter may be one wherein the range of addition processing is small in the vicinity of the center (χ=0), but wherein the range of addition processing becomes larger as the distance from the center becomes greater. If this filter is used, an image will result which creates a sense of speed, the image flowing more and more as it becomes more distant from the near content image.

In the description given in the foregoing, the filter is deployed for the far content image g2, but the present invention is not limited thereto or thereby. Filters may be deployed for both the near content image g1 and the far content image g2, or a filter may be deployed only for the near content image g1.

Embodiment 6.

To obtain the near content image g1 and the far content image g2, it is only necessary to take the pictures using an ordinary digital camera and changing the focus. If this is done in the ordinary way, however, the camera position and orientation will often change so that the near content image g1 and far content image g2 are shifted out of alignment. If that shifting is very slight, correction can be made by the registration described earlier. If the shifting is large, however, much time will be required for a complete correction. That being so, an apparatus is wanted that is capable of obtaining two images with little shifting by a simple operation.

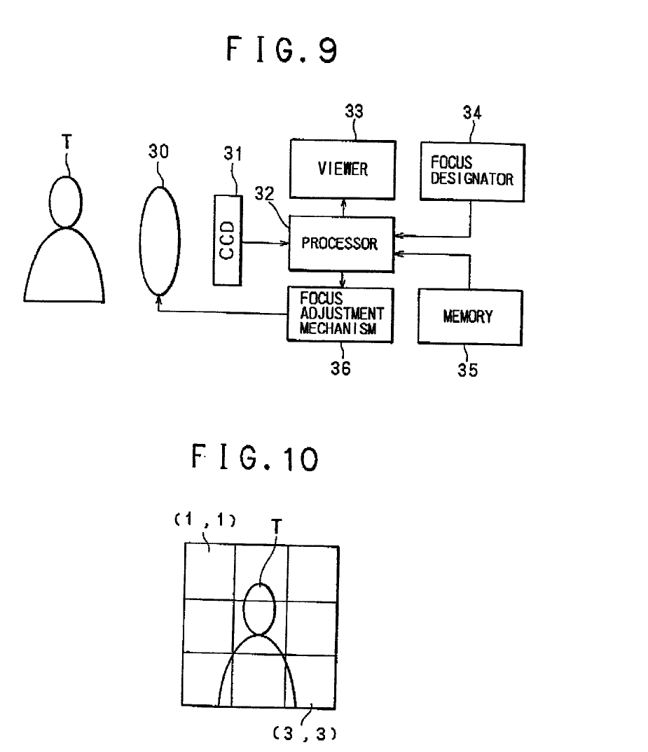

A block diagram of this type of apparatus is given in FIG. 9. Light that has passed through a lens 30 enters a CCD 31 and is converted to image data by a processor. An image is displayed through a viewer 33 which the user can see. The image displayed through the viewer 33 is divided into prescribed regions as diagrammed in FIG. 10. In the example diagrammed in FIG. 10, the image is divided into a total of 9 regions. While viewing the image through the viewer 33, the user manipulates a focus designator 34 and designates at least two regions that are to be brought into focus. In order to obtain a near content image g1, for example, focus is designated for the region (2, 2) in the middle of the image occupied by the subject T being photographed, and to obtain a far content image g2, focus is designated for the region (1, 1) at the upper left. Upon receiving a signal from the focus designator 34, the processor 32 drives a focus adjustment mechanism 36. The focus adjustment mechanism 36 brings a designated region into focus and takes a picture. Data for the image captured is stored in a memory 35. Then the focus adjustment mechanism 36 brings the next designated region into focus, takes a picture, and stores that image data in the memory 35.

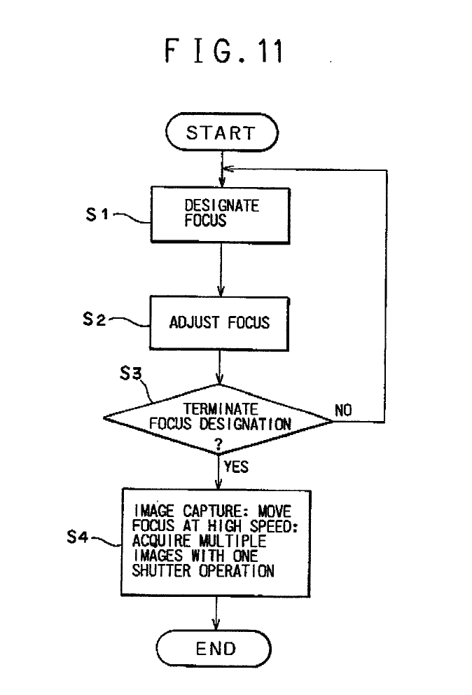

The processing diagrammed in FIG. 11 is also possible. The focal point is moved at high speed and a plural number of images is acquired with one shutter operation. When the focus is being designated, data necessary to focusing are set and stored in memory, making high speed focusing possible.

Based on the apparatus of Embodiment 6 in this invention, the near content image g1 and far content image g2 can be captured almost simultaneously with a simple operation. It is thus possible to obtain two images, namely the near content image g1 and the far content image g2, with little misalignment in terms of rotation, size, and position. Nor is the number of regions limited to two. If three or more are designated, three near content images and/or far content images can be obtained.

Embodiment 7.

<Generation of Completely Focused Image Based on Multiple Images, and Acquisition of Three-Dimensional Structures>

In the foregoing descriptions, a completely focused image was generated using two images, namely a near content image and a far content image. This poses no limitation, however, and a completely focused image can be generated using three or more images. A completely focused image can be generated, based on multiple insect microscopic images taken while minutely shifting the focus, for example. In ordinary microscopic image sharpening processing, in-focus determinations are made using high-band components isolated by a brightness level fluctuating filter. In this embodiment of the present invention, however, in-focus determinations are made by generating out-of-focus images and successively comparing them. Also, by providing depth information for each of k images based on the in-focus position, three-dimensional structures can be acquired for the subject.

In this embodiment of the invention, a completely focused image is reconstructed using a selective integration method that employs consecutive comparisons.

With a conventional selective integration method, blurred images are produced wherein a blur function is repeatedly convoluted for two captured images, and these are compared with another image. In the case of microscopic images where the focus is minutely changed, the reliability deteriorates in determinations made with only two images.

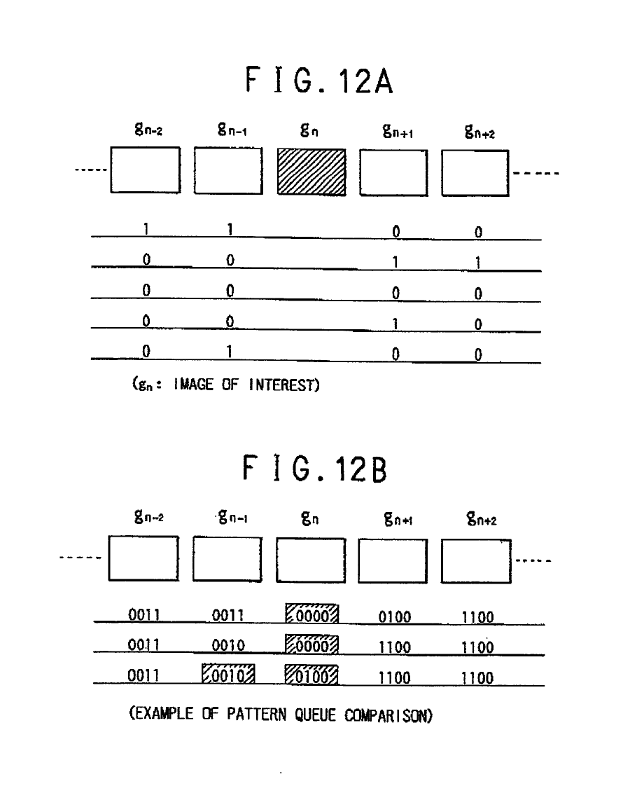

For that reason, comparisons are made for the subject image with a plurality of images in front of and behind the subject image (two in front and two behind for a total of four, for example), and the final determination is made using a determination pattern queue. As diagrammed in FIG. 12(a), for example, a plurality of images gn−2, gn−1, gn, gn+1, and gn+2 are arranged in in-focus order. The image gn−2 is in focus in the distance and the image gn+2 is in focus close up. The image of interest is the image gn. Then, taking some portion of the image of interest gn as reference, a determination is made as to whether something has been brought into focus (in focus) or not (out of focus). More specifically, a first portion of the image of interest gn is compared against corresponding portions in the other images gn−2, gn−1, gn+1, and gn+2, and determinations are made as to whether these are in focus or out of focus. In-focus/out-of-focus determinations can be made, for example, on the basis of Gaussian filter parameters. A determination pattern such as the “1, 1, 0, 0” indicated in FIG. 12(a), for example, is generated. Here, 0 and 1 indicate more in focus or more out of focus, comparing each subject image. That is, the first portion here is out of focus in the images gn−2 and gn−1, but in focus in the images gn+1 and gn+2. From this it is inferred that there is a possibility that the first portion is out of focus in the image of interest gn, but in focus in the images gn+1 and gn+2. Similarly, the determination pattern “0, 0, 1, 1” is obtained for a second portion in the image of interest gn, “0, 0, 0, 0” is obtained for a third portion therein, “0, 0, 1, 0” for a fourth portion therein, and “0, 1, 0, 0” for a fifth portion therein.

As is evident from the foregoing, when the pattern “0, 0, 0, 0” is obtained, which means that some portion in the image of interest gn is in focus in all of the images, the most focused image can be selected if that portion is adopted.

The processing described above is performed for a plurality of images, . . . , gn−2, gn−1, gn, gn+1, gn+2, . . . Thereupon, a pattern queue like that diagrammed in FIG. 12(b) is obtained. Each pattern means the pattern obtained when the processing diagrammed in FIG. 12(a) is performed with the image thereabove as the image of interest. If interest is directed to the first stage (first portion), the image gn may be adopted for that portion since it is known that the image gn pattern is most in focus at “0, 0, 0, 0.” The patterns for the other images gn−2, gn−1, gn+1, and gn+2 are “0, 0, 1, 1,” “0, 0, 1, 1,” “0, 1, 0, 0,” and “1, 1, 0, 0,” respectively, and there is a high probability that those images are not in focus. The same is true for the second stage (second portion). For the third stage (third portion), the patterns for the images gn−2, gn−1, gn, gn+1, and gn+2 are “0, 0, 1,” “0, 0, 1, 0,” “0, 1, 0, 0,” “1, 1, 0, 0,” and “1, 1, 0, 0,” and there is no most-focused pattern. If comparisons are made among the images gn−2, gn−1, gn, gn+1, and gn+2 overall, however, it may be said, in relative terms, that the patterns for the images gn−1 and gn are comparatively in focus because those patterns have three in-focus 0's. In the third stage, therefore, either the image gn−1 or gn is selected. It is believed furthermore that the in-focus point is between the images gn−1 and gn in the third stage in this example.

As described in the foregoing, the processing diagrammed in FIG. 12(a) is performed for all the images and a pattern queue like that in FIG. 12(b) is obtained for each image. Thereupon, by comparing the patterns in the images being compared as per the foregoing, it is decided that either the image gn−1 or gn in FIG. 12(b) is the image that is most in focus. Thus, in this embodiment, in-focus determinations for each image are made from the pattern queues resulting from comparing all of the images. High precision can be determined using this process. The processing required therefor is not all that complex, and that processing can be done in a comparatively short time.

From the results of the in-focus region determinations described above, moreover, it is seen that it is possible to impart, as depth information, information to the effect that the image where the pixels are in focus is the n'th from the shortest focal length. For example, it the first portion has been adopted from the image gn, it can be determined that that first portion is at an in-focus position in the image gn. It can also be determined that the third portion is in focus at a position between the images gn−1 and gn. Furthermore, from the fact that, in this embodiment, the same subject is captured while consecutively moving the point of focus little by little, the in-focus position can be obtained simply and comparatively accurately based on the initial focus position and final focus position.

Based on this embodiment of the present invention, a completely focused image can be obtained with good precision by consecutively comparing a plurality of microscopic images. Three-dimensional structures for the subject can also be known based on the in-focus information.

Embodiment 8.

In Embodiment 1 of the invention it is necessary to estimate blur amounts (R1 and R2). Gaussian filters are used in blur processing, but the blur amounts can be varied by adjusting these parameters. That being so, by estimating the Gaussian filter parameters (iterations), blur amounts can also be estimated.

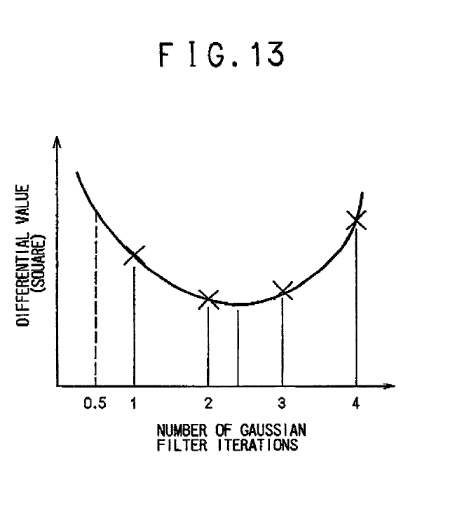

Such procedures are described with reference to FIG. 13. This is a graph wherein is plotted the relationship between Gaussian filter iterations and errors. On the vertical axis are plotted square differential values between an unblurred image and an image subjected to a Gaussian filter. On the horizontal axis are plotted Gaussian filter iterations. As is evident from this graph, a curve is formed that bulges down at the bottom. This curve can be approximated by a third-degree curve.

When the parameters are made 1, 2, 3, and 4, it is seen that the minimum value occurs between 2 and 3. In order to derive more accurate parameters, a third-degree curve is derived that approximates the graph in FIG. 13. Then the minimum value on that third-degree curve is found, whereupon the parameter at that time is found (approximately 2.4 in Fig. 13). Blur amounts can be accurately estimated using this procedure.

In actuality, moreover, differential values may be derived for cases where the parameter=0, say 0.5, for example, and an approximate curve derived taking such into consideration. It was demonstrated in simulations that better results are obtained by establishing the procedures in this

The present invention is not limited to or by the embodiment described in the foregoing, but can be variously modified, within the scope of the inventions described in the claims. Such modifications, needless to say, are also comprehended within the scope of the present invention.

In this specification, furthermore, what are termed means do not necessarily mean physical means, and cases are also comprehended wherein the functions of these means are implemented by software. Moreover, the functions of one kind of means may be implemented by two or more kinds of physical means, or, conversely, the functions of two or more kinds of means may be implemented by one kind of physical means.

What is claimed is:

1. An arbitrarily focused image synthesizing apparatus comprising:
a first filter for converting a first image that is in focus in a first portion based on a given first blur parameter;
a second filter for converting a second image that is in focus in a second portion based on a given second blur parameter; and
a synthesizer for synthesizing output of said first filter and output of said second filter and generating an arbitrarily focused image.

2. The arbitrarily focused image synthesizing apparatus according to claim 1, further comprising:
a brightness compensator for performing brightness correction in image block units so that the brightness of said first image and of said second image become about the same, and supplying said images after brightness correction to said first filter and said second filter.

3. The arbitrarily focused image synthesizing apparatus according to claim 2, wherein said brightness compensator uses correction parameters of the block for the center pixel in each block and uses interpolated correction parameters for the other pixels so as to reduce the variation in correction between the blocks.

4. The arbitrarily focused image synthesizing apparatus according to claim 1, further comprising:
a positioning unit that positions said first image and said second image, based on a brightness distribution obtained by projecting image data in horizontal and vertical directions, and supplying positioned images to said first filter and said second filter.

5. The arbitrarily focused image synthesizing apparatus according to claim 1, further comprising:
a positioning unit that orders each of said first image and said second image hierarchically according to resolution, estimates parameters of differences in the rotation, resizing, and translation in said first image and said second image over a wide search range at a level where the resolution is low, performing matching at each level from upper level to lower level sequentially, while limiting the search range to the margins of the parameters estimated at the upper level, finds the parameters between said first image and said second image so as to position said first image and said second image, and supplying positioned images to said first filter and said second filter.

6. The arbitrarily focused image synthesizing apparatus according to claim 1, further comprising:
a special effects filter for performing prescribed processing on output of said second filter;
wherein said synthesizer synthesizes output of said first filter and output of said special effects filter and generates an arbitrarily focused image.

7. The arbitrarily focused image synthesizing apparatus according to claim 6, wherein said special effects filter adds together pixel data in the lateral direction.

8. The arbitrarily focused image synthesizing apparatus according to claim 6, wherein said special effects filter adds together pixel data in the vertical direction.

9. The arbitrarily focused image synthesizing apparatus according to claim 6, further comprising, on the input side of said special effects filter, a rectangular-to-polar coordinate converter for converting coordinates of respective image data from rectangular coordinates to polar coordinates, and, on the output side of said special effects filter, a polar-to-rectangular coordinate converter for restoring coordinates of image data from polar coordinates back to rectangular coordinates.

10. The arbitrarily focused image synthesizing apparatus according to claim 1, wherein said first image is a near content in-focus image in which near scenic content is focused and said second image is a far content in-focus image in which far scenic content is focused.

11. The arbitrarily focused image synthesizing apparatus according to claim 1, wherein said first filter has characteristic as follows,
$${K}_{a} ( ξ , η ) = \{ \begin{matrix}\frac{{R}_{1}^{2} + {R}_{b}^{2} - {R}_{a}^{2}}{{R}_{1}^{2} + {R}_{2}^{2}} , & ξ = η = 0 \\ \frac{{H}_{a} - {H}_{b} {H}_{1}}{1 - {H}_{1} {H}_{2}} , & otherwise\end{matrix} \qquad ( 23 )$$
said second filter has characteristic as follows,
$${K}_{b} ( ξ , η ) = \{ \begin{matrix}\frac{{R}_{2}^{2} + {R}_{a}^{2} - {R}_{b}^{2}}{{R}_{1}^{2} + {R}_{2}^{2}} , & ξ = η = 0 \\ \frac{{H}_{b} - {H}_{a} {H}_{1}}{1 - {H}_{1} {H}_{2}} , & otherwise\end{matrix} \qquad ( 24 )$$
wherein R1, R2, Ra, Rb represent blur radius and H1, H2, Ha, Hb represent blur function, and
said synthesizer adds output of said first filter to output of said second filter.

12. The arbitrarily focused image synthesizing apparatus according to claim 11, wherein said blur radiuses are selected so that square differential value between an unblurred image and an image subjected to a Gaussian filter is minimized.

13. An arbitrarily focused image synthesizing apparatus comprising:
a determinator for arranging, in focal point order, first to Nth images wherein first to Nth portions, respectively, are in focus based on first to Nth given blur parameters, and determining whether or not one portion in an i'th image that is one of those images is in focus in a plurality of images in front and back thereof taking that i'th image as center;
a comparator for comparing determination patterns of said determinator to determine which images that portion is in focus in; and
a synthesizer for synthesizing said first to Nth images according to comparison results from said comparator and generating a completely focused image.

14. The arbitrarily focused image synthesizing apparatus according to claim 13, wherein said determinator comprises: a Gaussian filter for subjecting said i'th image to filter processing while varying parameters; a differential processor for finding differential values of said plurality of images in front and back with output of said Gaussian filter; and an estimator for estimating said parameters by finding the value at which said differential value is minimized.

15. A plural image simultaneous capturing camera comprising:
a camera element;
a processor for receiving signals from said camera element and converting same to image data;
a display unit for displaying image data processed by said processor;
a focal point designator for designating a plurality of subjects inside an image and requesting a plurality of images having respectively differing focal points;
a focal point adjustment mechanism for setting focal point positions using the designation of said focal point designator; and
a memory for storing image data,
wherein said processor respectively and in order focuses said plurality of subjects designated, respectively captures those subjects, and respectively stores in said memory plural image data which has been obtained.

16. The plural image simultaneous capturing camera according to claim 15, wherein a plurality of images having different focal points are captured with one shutter operation.

17. The plural image simultaneous capturing camera according to claim 15, further comprising an arbitrarily focused image synthesizing apparatus comprising: a first filter for converting a first image that is in focus in a first portion based on a given first blur parameter; a second filter for converting a second image that is in focus in a second portion based on a given second blur parameter; a synthesizer for synthesizing output of said first filter and output of said second filter and generating an arbitrarily focused image; and a brightness compensator for performing brightness correction in image block units so that the brightness of said first image and of said second image become about the same, and supplying images after brightness correction to said first filter and said second filter.

18. The plural image simultaneous capturing camera according to claim 15, further comprising an arbitrarily focused image synthesizing apparatus comprising: a first filter for converting a first image that is in focus in a first portion based on a given first blur parameter; a second filter for converting a second image that is in focus in a second portion based on a given second blur parameter; a synthesizer for synthesizing output of said first filter and output of said second filter and generating an arbitrarily focused image; and a positioning unit that positions said first image and said second image, based on a brightness distribution obtained by projecting image data in horizontal and vertical directions, and supplying positioned images to said first filter and said second filter.

19. The plural image simultaneous capturing camera according to claim 15, further comprising an arbitrarily focused image synthesizing apparatus comprising: a first tilter for converting a first image that is in focus in a first portion based on a given first blur parameter; a second filter for converting a second image that is in focus in a second portion based on a given second blur parameter; a special effects filter for performing prescribed processing on output of said second filter; and a synthesizer for synthesizing output of said first filter and output of said special effects filter and generating an arbitrarily focused image.

20. The plural image simultaneous capturing camera according to claim 19, wherein, provided on the input side and output side of said special effects filter are a rectangular coordinate to polar coordinate converter for converting coordinates of respective image data from rectangular coordinates to polar coordinates, and a polar coordinate to rectangular coordinate converter for restoring coordinates of image data from polar coordinates back to rectangular coordinates.
